(19) United States
(12) Patent Application Publication
(10) Pub. No.: US 2008/0162636 A1
(43) Pub. Date: Jul. 3, 2008

(54) SYSTEM AND METHOD FOR REPLYING TO QUESTIONS ON-LINE

(75) Inventors: CHUNG-I LEE, Tu-Cheng (TW); HAI-HONG LIN, Shenzhen (CN); YUAN WEN, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) Co., LTD, Shenzhen City (CN); HON HAI PRECISION INDUSTRY CO., LTD., Tu-Cheng (TW)

(21) Appl. No.: 11/778,087

(22) Filed: Jul. 16, 2007

(30) Foreign Application Priority Data
Dec. 27, 2006 (CN) 200610201428.8

(51) Int. Cl. G06F 15/16

(52) U.S. Cl. 709/204

(57) ABSTRACT

The present invention provides a method for replying to questions on-line. The method includes: defining multiple roles, and assigning the roles to users, wherein the roles comprise questioners, repliers and auditors; setting categories of the questions and a replying process and an auditing process for each category of questions correspondingly; receiving the questions and displaying the questions on Web pages; confirming corresponding categories of the questions; confirming the replying process and the auditing process corresponding to each category; informing corresponding repliers to give preliminary replies; informing corresponding auditors to auditing the preliminary replies; verifying whether the preliminary replies are correct; and displaying the correct replies on the Web pages. A related system is also disclosed.

### BACKGROUND OF THE INVENTION

1. Field of the Invention

The present invention relates to systems and methods for replying to questions especially to a system and method for replying to questions on-line.

2. Description of Related Art

With the continual development of recent technology of network speed and coverage, data are being exchanged rapidly through the networks. It is convenient for users at different places to communicate with one another on the Web through the networks. Generally, most Web sites provide platforms for the users to express their opinions freely. The Web sites allow the users to browse information, leave their opinions, and ask questions. The users may also acquire online replies of the questions from other users.

However, the replies given by different users maybe distinct, which cause confusion of the questioners in determining which one is suitable. Specifically, most Web sites do not provide professional assistances for the questions when the questioners are puzzled about special questions, such as legal affairs, health information, and so on. Herein the professional assistances may include offering preliminary professional replies to questioners, auditing the preliminary replies by a senior professional (i.e., lawyer, specialist, etc) before publishing the replies, and publishing the audited replies on Web pages. The audited replies may be used as professional guidance to the questioners.

What is needed is a system and method that can provide a function of replying to the questions on-line so as to give the users professional replies audited by appointed specialist.

### SUMMARY OF THE INVENTION

A system for replying to questions on-line is provided. The system includes a role defining module, a setting module, a question manager, an informing module and an auditing module. The role defining module is configured for defining multiple roles, and for assigning the roles to users, wherein the roles comprise questioners, repliers and auditors. The setting module is configured for setting categories of the questions, and for setting a replying process and an auditing process for each category of questions correspondingly. The question manager is configured for receiving the questions and displaying the questions on Web pages, for confirming corresponding categories of the questions, and for confirming the replying process and the auditing process corresponding to each category. The informing module is configured for informing corresponding repliers to give preliminary replies to the questions according to the confirmed replying process, and for informing corresponding auditors to audit the preliminary replies according to the confirmed auditing process. The auditing module is configured for verifying whether the preliminary replies are correct, and for displaying the correct replies on the Web pages.

Furthermore, a method for replying to questions on-line is provided. The method includes the steps of: defining multiple roles, and assigning the roles to users, wherein the roles comprise questioners, repliers and auditors; setting categories of the questions and a replying process and an auditing process for each category of questions correspondingly; receiving the questions and displaying the questions on Web pages; confirming corresponding categories of the questions; confirming the replying process and the auditing process corresponding to each category; informing corresponding repliers to give preliminary replies to the questions according to the confirmed replying process; informing corresponding auditors to audit the preliminary replies according to the confirmed auditing process; verifying whether the preliminary replies are correct; and displaying the correct replies on the Web pages.

Other advantages and novel features of the present invention will become more apparent from the following detailed description of preferred embodiments when taken in conjunction with the accompanying drawings.

### BRIEF DESCRIPTION OF THE DRAWINGS

FIG. 1 is a schematic diagram of a hardware configuration of a system for replying to questions on-line in accordance with a preferred embodiment;

FIG. 2 is a schematic diagram of main software function modules of the system of FIG. 1;

FIG. 3 is a flowchart of a method for replying to questions on-line in accordance with a preferred embodiment; and

FIG. 4 is a flowchart of a method for auditing preliminary replies on-line.

### DETAILED DESCRIPTION OF THE INVENTION

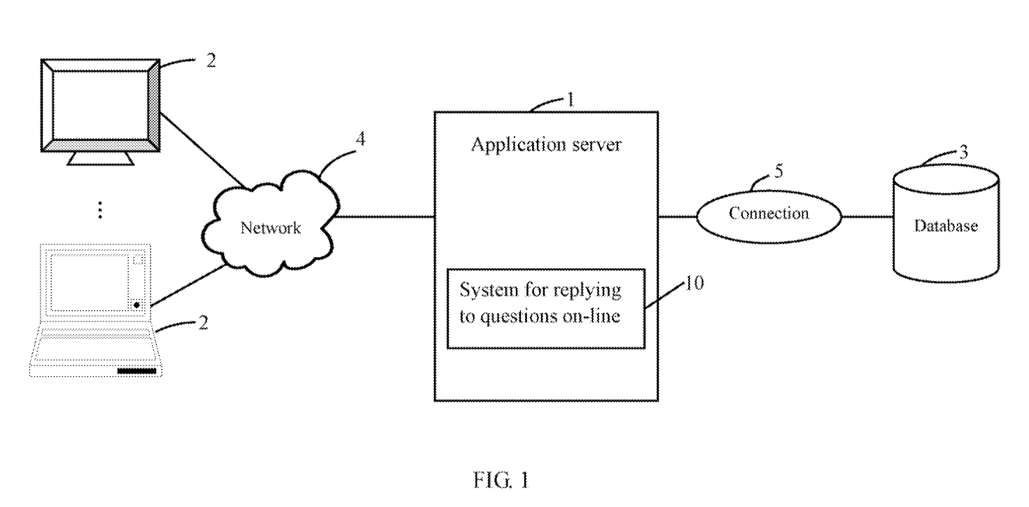

FIG. 1 is a schematic diagram of a hardware configuration of a system for replying to questions on-line (hereinafter, “the system”) in accordance with a preferred embodiment. The system 10 is installed in an application server 1. The application server 1 is electronically connected with a plurality of distributed client computers 2 (only two shown) via a network 4. The network 4 may be an intranet, the Internet, or any other type of communication channel.

Each of the plurality of client computers 2 is configured (i.e., structured and arranged) for providing an interactive interface that enables users to perform relevant operations to acquire replies on their questions on-line. The operations may include logging in the system 10, inputting the questions, viewing the replies to the questions, and so on. The client computer 2 may be a personal computer, a laptop, a portable handheld device, a mobile phone, or other suitable electronic communication terminals.

The application server 1 may be further electronically connected with a database 3 via a connection 5. The database 3 is configured for storing various kinds of data, such as information of the users, the questions, the replies, opinions, and so on. The database 3 may be a hard disk (not shown) located in the application server 1, or a storage device located outside of the application server 1. The connection 5 is a database connectivity, such as an open database connectivity (ODBC) or an object link and embedding database (OLE DB)

The system 10 is configured for setting multiple roles and assigning the roles to the users, upon receiving the questions and starting up corresponding replying processes and auditing processes according to categories of the questions, and for giving correct replies to questioners on-line. The system 10 may run in the application server 1 as independent software, it may also be a subsystem or a plug-in program of other system in the application server 1. For example, the system 10 may be put into different Web sites or a platform in the Web sites, which enable users to use the Web sites, or the platform to reply to the questions on-line.

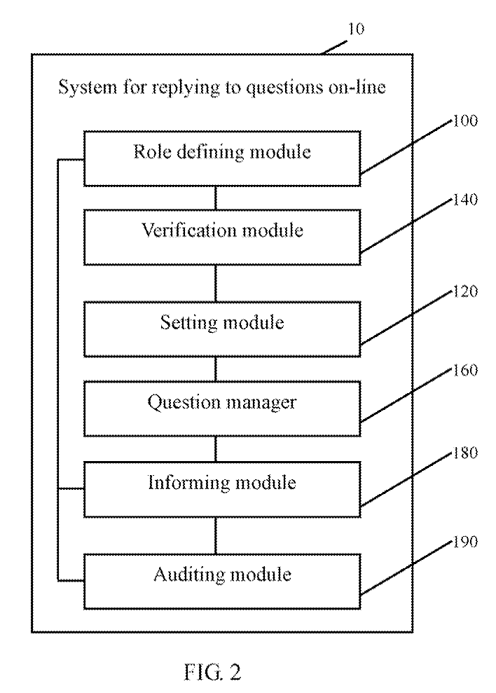

FIG. 2 is a schematic diagram of main software function modules of the system 10. The system 10 may include a role defining module 100, a setting module 120, a verification module 140, a question manager 160, an informing module 180, and an auditing module 190.

The role defining module 100 is configured for defining multiple roles, and for assigning the roles to users. The roles include guests, administrators, questioners, repliers, and auditors. The roles may be newly added, deleted, or modified by the role defining module 100 according to actual demands. A registered user may be assigned with at least one non-guest role, and an unregistered user will only be considered as a guest.

The role defining module 100 is also configured for setting authorities of different roles. The authorities limit operations of the roles for the purpose of preventing illegal operations. For example, the guests only have one authority for browsing Web pages, the questioners have the authorities for browsing the Web pages and inputting their questions and opinions, the repliers have the authorities for viewing the questions and giving preliminary replies to the questions, and the auditors have the authorities for viewing and verifying the preliminary replies, allowing correct replies to be published on the Web pages, and providing corresponding opinions on the questions or the replies. The administrators have all of the authorities set by the role defining module 100.

The setting module 120 is configured for setting categories of the questions, and for setting a replying process and an auditing process for each category of questions correspondingly. For example, if the system 10 is applied in a Web site relating to legal affairs so as to provide a function of replying to the questions, the categories of the questions may be set according to various types of laws, such as patent laws, criminal laws, civil laws, etc. The categories of the questions may also be set according to other standards, such as degrees of difficulties, and so on.

The replying process and the auditing process are set by configuring one or more repliers to give the preliminary replies to the questions, and configuring one or more auditors to audit, select, modify, or send back the preliminary replies. For example, the setting module 120 sets one or more assistant lawyers to give the preliminary replies, and sets one or more senior lawyers to audit the preliminary replies and verify whether the preliminary replies are correct.

The setting module 120 is also configured for setting publication modes of the questions, which comprise a private mode and a public mode. Under the private mode, only the questioners, the repliers, the auditors, and the administrators are allowed to view the questions and the correct replies. Under the public mode, all users are allowed to view the questions and the correct replies, such as the registered users and the unregistered users, and the registered users may further give their opinions on the questions or the replies.

The setting module 120 is further configured for setting information vision modes on the Web pages. The information includes the questions, the replies, the opinions, and other information. The questions, the replies provided by the repliers, the opinions given by the auditors, and the opinions given by other registered users are being displayed with different information vision modes so as to enable the users to identify the information quickly. For example, the information vision modes may distinguish the information from fonts, colors, locations, or other means.

The verification module 140 is configured for verifying passwords input by the users when the users request to log in the system 10, and verifying whether the operations of the users are valid according to the assigned roles of the users and the authorities of the roles, allowing the users to perform the operations if the operations are valid; and denying the operations if the operations are not allowed to the users.

The question manager 160 is configured for providing a user interface for the users to input the questions, select the categories of the questions, and select the publication modes. The question manager 160 is also configured for receiving the questions and displaying the questions on the Web pages according to the selected publication mode.

The question manager 160 is further configured for confirming the replying processes and the auditing processes corresponding to the selected categories.

The informing module 180 is configured for informing corresponding repliers to give the preliminary replies to the questions according to the confirmed replying process, and for informing corresponding auditors to audit the preliminary replies according to the confirmed auditing process.

The informing module 180 is also configured for informing the repliers to modify the preliminary replies if the preliminary replies are incorrect, and for informing the questioners to view the correct replies on the Web pages. The informing module 180 may utilize instant messages, e-mails, phone calls or other means to inform the users (i.e., the questioners, the repliers, and the auditors) according to contact means of the users, and may also inform the users repeatedly by setting timers if the users have no corresponding responses. The contact means are recorded when the users registered in the system 10. The informing module 180 is further configured for informing the administrators to modify the replying process or the auditing process by utilizing the setting module 120 if needed.

The auditing module 190 is configured for providing a plurality of clickable buttons to the auditors, such as an “agree” button, a “disagree” button, a “comment” button, etc. The auditing module 190 is also configured for verifying whether the preliminary replies are correct by identifying which button is being clicked by the auditor. Specifically, if the “agree” button is clicked, the preliminary replies are deemed correct by the auditing module 190; and if the “disagree” button is clicked, the preliminary replies are deemed incorrect by the auditing module 190.

The auditing module 190 is further configured for displaying the correct replies on the Web pages according to the publication mode selected by the questioners, for reflecting opinions given by the auditors, and for displaying the opinions on the Web pages. The repliers are required to modify the preliminary repliers if the preliminary replies are incorrect. The auditors may give their opinions by clicking the “comment” button.

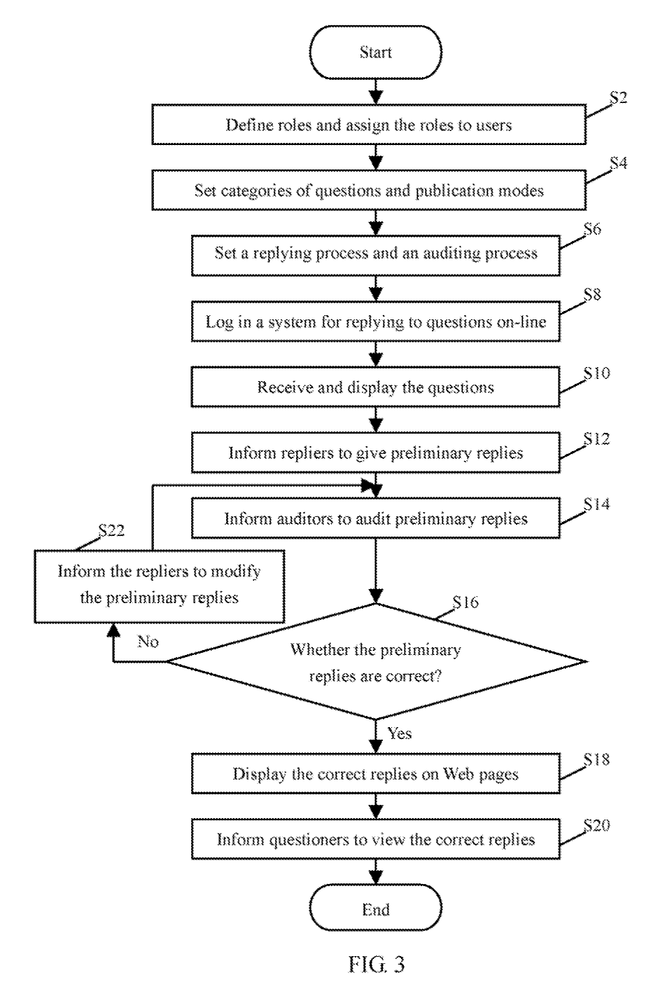

FIG. 3 is a flowchart of a method for replying to questions on-line. In step S2, the role defining module 100 defines multiple roles, assigns the roles to different users, and sets the authorities of different roles. The roles include guests, administrators, questioners, repliers, and auditors. The roles may be newly added, deleted, or modified by the role defining module 100 according to actual demands.

In step S4, the setting module 120 sets the categories of the questions, and the publication modes of the questions, which comprise a private mode and a public mode.

In step S6, the setting module 120 sets the replying process and the auditing process for each category of questions correspondingly by setting one or more repliers to give the preliminary replies to the questions, and setting one or more auditors to audit, select, or modify the preliminary replies.

In step S8, the verification module 140 verifies the passwords input by the questioners when logging in the system 10. If the passwords are valid, the questioner inputs the question, selects the category of the question and selects the publication modes of the question through the user interface provided by the question manager 160. The verification process of the verification module 140 includes the following steps: receiving the user name and the password of the questioner; verifying the user name and the password and determining whether the user name and the password are valid; confirming the authorities of the questioner if the user name and the password are valid; limiting following operations of the questioner according to the authorities; allowing the questioner to execute valid operations; and denying the operations that are not allowed to the users. The above-mentioned verification process is applicable to other users that are assigned with different roles.

In step S10, the question manager 160 receives the question, displays the question on the Web pages according to the selected publication mode, confirms corresponding category of the question according to user selection, and confirms the replying process and the auditing process corresponding to the category.

In step S12, the informing module 180 informs corresponding repliers to give the preliminary replies to the questions according to the confirmed replying process. In step S14, the informing module 180 informs corresponding auditors to audit the preliminary replies according to the confirmed auditing process.

In step S16, the auditing module 190 verifies whether the preliminary replies are correct by identifying which button is clicked by the auditor. The buttons include the “agree” button, the “disagree” button, and the “comment” button.

If the preliminary replies are correct, in step S18, the auditing module 190 displays the correct replies on the Web pages, and reflects the opinions given by the auditors. Otherwise, if the replies are incorrect, the procedure goes to step S22 directly. In step S20, the informing module 180 informs the questioner to view the correct replies and the opinions on the Web pages.

In step S22, the informing module 180 informs the repliers to modify the preliminary replies, and the procedure returns to step S14. That is, the informing module 180 informs the auditors to audit the modified replies.

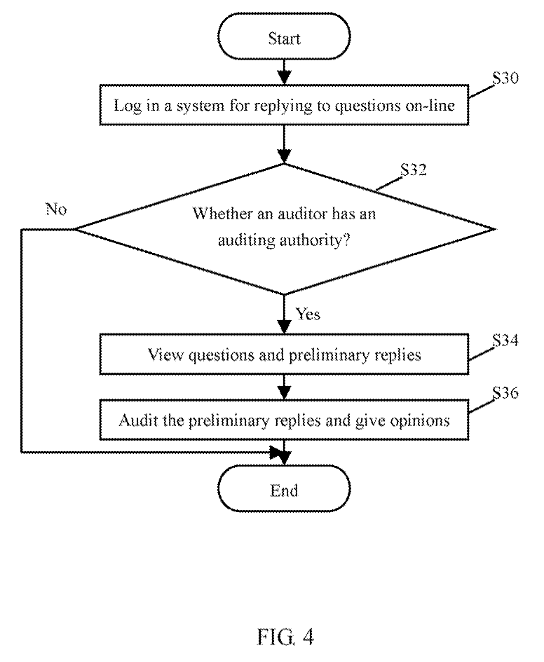

FIG. 4 is a flowchart of a method for auditing the preliminary replies on-line. In step S30, the auditor logs in the system 10 after receiving information from the informing module 180. In step S32, the verification module 140 verifies whether the auditor has an auditing authority. If the auditor has an auditing authority, in step S34, the auditor is allowed to view the questions and corresponding preliminary replies from the repliers. Otherwise, if the auditor does not have the auditing authority, the procedure ends.

In step S36, the auditor audits the preliminary replies and verifies whether the preliminary replies are correct, and then clicks corresponding button provided by the auditing module 190. For example, if the preliminary replies are correct, the auditor clicks the “agree” button; otherwise, if the preliminary replies are incorrect, the auditor clicks the “disagree” button. Furthermore, the auditor may click the “comment” button to provide corresponding opinions, and then reflect the opinions on the Web pages by the auditing module 190.

It should be emphasized that the above-described embodiments, particularly, any “preferred” embodiments, are merely possible examples of implementations, merely set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s) and protected by the following claims.

What is claimed is:

1. A system for replying to questions on-line, the system comprising:
a role defining module configured for defining multiple roles, and for assigning the roles to users, wherein the roles comprise questioners, repliers and auditors;
a setting module configured for setting categories of the questions, and for setting a replying process and an auditing process for each category of questions correspondingly;
a question manager configured for receiving the questions and displaying the questions on Web pages, for confirming corresponding categories of the questions, and for confirming the replying process and the auditing process corresponding to each category;
an informing module configured for informing corresponding repliers to give preliminary replies to the questions according to the confirmed replying process, and for informing corresponding auditors to audit the preliminary replies according to the confirmed auditing process; and
an auditing module configured for verifying whether the preliminary replies are correct, and for displaying the correct replies on the Web pages.

2. The system as claimed in claim 1, wherein the role defining module is further configured for setting authorities of different roles.

3. The system as claimed in claim 2, further comprising a verification module configured for verifying whether operations of the users are valid according to the assigned roles of the users and the authorities of the roles, and for denying operations that are not allowed to the users.

4. The system as claimed in claim 1, wherein the setting module is further configured for setting publication modes of the questions, which comprise a private mode and a public mode, wherein the private mode only allows the questioners, the repliers, and the auditors to view the questions and the correct replies, and the public mode allows all users to view the questions and the correct replies.

5. The system as claimed in claim 1, wherein the informing module is further configured for informing the repliers to modify the preliminary replies that are audited as incorrect.

6. The system as claimed in claim 1, wherein the informing module is further configured for informing the questioners to view the correct replies on the Web.

7. The system as claimed in claim 1, wherein the auditing module is further configured for reflecting opinions given by the auditors and displaying the opinions on the Web pages.

8. A method for replying to questions on-line, the method comprising the steps of:
defining multiple roles, and assigning the roles to users, wherein the roles comprise questioners, repliers and auditors;
setting categories of the questions and a replying process and an auditing process for each category of questions correspondingly;
receiving the questions and displaying the questions on Web pages;
confirming corresponding categories of the questions;
confirming the replying process and the auditing process corresponding to each category;
informing corresponding repliers to give preliminary replies to the questions according to the confirmed replying process;
informing corresponding auditors to auditing the preliminary replies according to the confirmed auditing process;
verifying whether the preliminary replies are correct; and
displaying the correct replies on the Web pages.

9. The method according to claim 8, further comprising the step of:
setting authorities of different roles.

10. The method according to claim 9, further comprising the steps of:
verifying whether operations of the users are valid according to the assigned roles of the users and the authorities of the roles;
allowing the users to execute the operations if the operations are valid; and
denying the operations if the operations are not allowed to the users.

11. The method according to claim 8, further comprising the step of:
setting publication modes of the questions, which comprise a private mode and a public mode, wherein the private mode only allows the questioners, the repliers, and the auditors to view the questions and the correct replies, and the public mode allows all users to view the questions and the correct replies.

12. The method according to claim 8, further comprising the step of:
informing the repliers to modify the preliminary replies.

13. The method according to claim 8, further comprising the step of:
informing the questioners to view the correct replies on the Web.

14. The method according to claim 8, further comprising the steps of:
reflecting opinions given by the auditors; and
displaying the opinions on the Web pages.
